(19) United States
(12) Patent Application Publication
(10) Pub. No.: US 2015/0178851 A1
(43) Pub. Date: Jun. 25, 2015

(54) INSURANCE PRODUCT MODEL RELATIONSHIPS

(71) Applicant: Guidewire Software, Inc., Foster City, CA (US)

(72) Inventors: Arjun Dutt, San Francisco, CA (US); Robert Theodore Anagnoson, San Mateo, CA (US)

(21) Appl. No.: 14/461,711

(22) Filed: Aug. 18, 2014

Related U.S. Application Data
(60) Provisional application No. 61/918,522, filed on Dec. 19, 2013.

(51) Int. Cl. G06Q 40/08; G06Q 10/06

(52) U.S. Cl. CPC G06Q 40/08; G06Q 10/067

(57) ABSTRACT

Managing insurance product model relationships is disclosed. A dependency data store storing dependency relationships of a plurality of source insurance product model patterns and a corresponding plurality of target insurance product model patterns is maintained. It is detected that a user interface display associated with a source insurance product model pattern is to be updated. The dependency data store is checked to identify a dependency relationship of the source insurance product model pattern and a corresponding target insurance product model pattern. A user interface display associated with the target insurance product model pattern is updated.

### CROSS REFERENCE TO OTHER APPLICATIONS

This application claims priority to U.S. Provisional Patent Application No. 61/918,522 (Attorney Docket No. GUIDP045+) entitled PRODUCT MODEL RELATIONSHIPS filed Dec. 19, 2013 which is incorporated herein by reference for all purposes.

### BACKGROUND OF THE INVENTION

Insurance software is required to manage and store large amounts of insurance related data for a vast array of insurance products and options that may be desired by various customers, e.g., insurance carriers. Some insurance software uses an insurance product model to organize insurance related data. Users may use specialized software to view, create, and make changes to an insurance product model. There may be many instances of interdependencies in an insurance product model. The configuration for modeling the interdependencies is tedious and often requires technical knowledge of the implementation.

### BRIEF DESCRIPTION OF THE DRAWINGS

Various embodiments of the invention are disclosed in the following detailed description and the accompanying drawings.

FIG. 1 is a block diagram illustrating an embodiment of a system for managing insurance product model relationships.

FIG. 2A is a diagram illustrating an embodiment of an interface for editing an insurance product model.

FIG. 2B is a diagram illustrating an embodiment of an interface for editing an insurance product model showing the navigation tree more fully expanded.

FIG. 3 is a diagram illustrating an example of an insurance product model relationship, wherein the type of relationship is dependent availability.

FIG. 4 is a diagram illustrating an example of an insurance product model relationship, wherein the type of relationship is dependent selection.

FIG. 5 is a diagram illustrating an example of an insurance product model relationship, wherein the type of relationship is dependent availability on a range.

FIG. 6 is a diagram illustrating an example of an insurance product model relationship, wherein the type of relationship is dependent exclusive.

FIG. 7 is a diagram illustrating an example of an insurance product model relationship, wherein the type of relationship is mutually exclusive.

FIG. 8 is a diagram illustrating an example of an insurance product model relationship, wherein the type of relationship is dependent grouping.

FIG. 9 is a diagram illustrating an embodiment of a user interface for configuring an insurance product model relationship from the coverage level.

FIG. 10 is a diagram illustrating an embodiment of a relationship rules user interface for a rule.

FIG. 11 is a diagram illustrating an embodiment of a user interface for configuring an insurance product model relationship from the coverage term level.

FIG. 12 is a diagram illustrating an embodiment of a relationship rules user interface for a rule.

FIG. 13 is a diagram illustrating an embodiment of a user interface for configuring an insurance product model relationship from the policy line level.

FIG. 14 is a diagram illustrating an embodiment of a relationship rules user interface for a rule.

FIG. 15 is a flow chart illustrating an embodiment of a process for managing insurance product model relationships.

FIG. 16 is a functional diagram illustrating a programmed computer system for managing insurance product model relationships in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

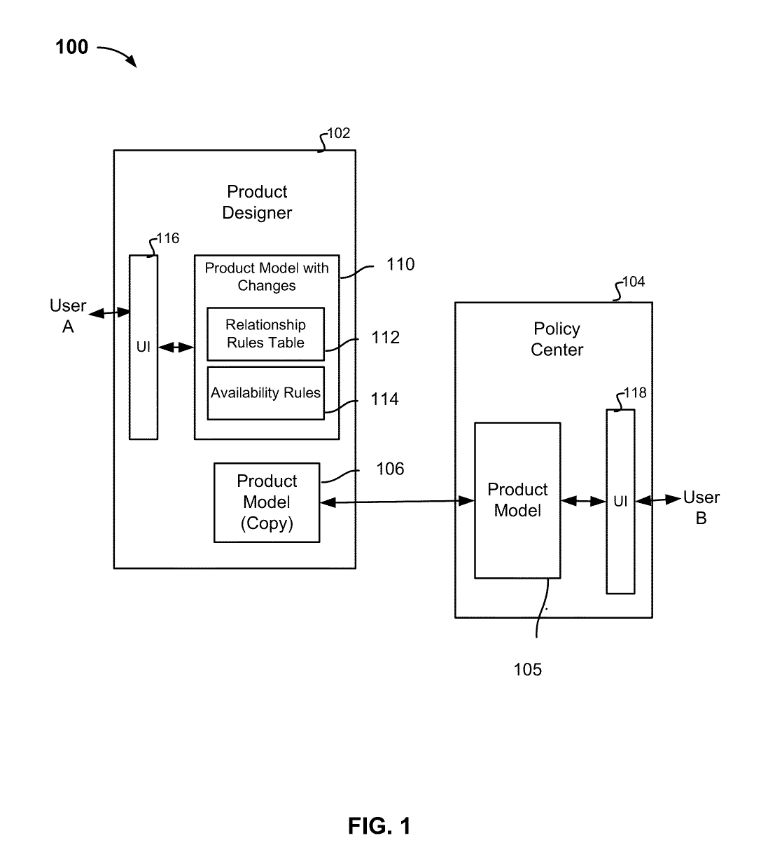

FIG. 1 is a block diagram illustrating an embodiment of a system for managing insurance product model relationships.

In this example, system 100 is shown to include product designer 102 and policy center 104, which are connected over a network (e.g., the Internet, a private network, or a combination). User A may use product designer 102 to configure, edit, or design various insurance products and associated information, such as homeowner's insurance or auto insurance, which may include: offerings, availability on policy lines, coverages, coverage terms, conditions, and exclusions. In some embodiments, product designer 102 resides on a separate web server and user A can login and use product designer 102 remotely from web browsers running on their laptop or other networked device. User B uses policy center 104 to produce instances of these insurance products for individual policies.

In this example, policy center 104 is shown to include insurance product model 105 and user interface 118. An insurance product model is a logical representation of insurance products and associated information, e.g., offered by a particular insurance company. In some embodiments, the insurance product model is implemented using XML files and/or stored in a database.

In some embodiments, an insurance product model comprising insurance policy metadata is provided in a computer memory. In some embodiments, a computer then serves to interpret this insurance product model to facilitate obtaining supplemental policy-specific data. In some embodiments, an insurance product model refers to metadata that defines the structure of a plurality of derived policies. While the model may contain information that forms part of the information included in the derived policies, it is distinct from, and shared across, all of the derived policies.

The insurance policy metadata may comprise, at least in part, data that defines elements of a corresponding insurance policy. Examples of metadata include, but are not limited to, data that defines policy lines, risk unit types, insurance coverage types, insurance coverage forms, contractual terms associated with insurance coverages (“coverage terms”), options associated with coverage terms, available endorsements, available choices for limits and deductibles, information about the availability of coverages, and so forth.

The supplemental policy-specific data can comprise information such as, but not limited to, actual coverage limits and coverage deductibles selected, coverage elections, risks being covered, a period of coverage, cost(s), applied endorsements, insured entity data, and so forth. By one approach the insurance policy metadata and the supplemental policy-specific data comprise separate and discrete data models and may, if desired, be stored separately from one another.

So configured, the insurance product model and the supplemental policy-specific data can be used to facilitate an insurance-related action. Examples of insurance-related actions include, but are not limited to, creating a new insurance policy, determining whether an insurance policy provides coverage with respect to a particular event, collecting additional information with respect to a particular event, identifying at least one insurance policy that is available to offer to an entity from amongst a plurality of candidate insurance policies, providing information to a user regarding which risk units are permitted to be covered by a given corresponding insurance policy, and so forth (to note but a few examples).

The insurance product model can be used to support managing new policy lines, coverage types, or risk units without requiring reprogramming of a hardcoded policy product embedded in the software code of a policy administration application. Instead, such new information may be incorporated into insurance product model metadata, which metadata is then interpreted and used to collect additional policy-specific information, and which may further facilitate performing an insurance-related action. This, of course, can be accomplished with a great reduction in time and effort and with considerably reduced exposure to coding mishaps.

The insurance policy metadata may comprise, at least in part, data that defines elements of a corresponding insurance policy. The insurance policy metadata may also comprise, at least in part, data that is common to a plurality of derived insurance policies. Examples of metadata include, but are not limited to, data that defines a policy line (that is, a set of related risk types and coverages that, taken together, make up a coherent package of insurance), at least one risk unit type (that is, a thing or circumstance that may be exposed to loss, which may also include, for example, the parameters needed to correctly represent that risk type for purposes of determining coverage and calculating the premium), insurance coverage types (that is, a set of types of available coverage, which may also include, for example, the parameters needed to determine the possible values of limits and deductibles), insurance coverage forms, and so forth.

In addition, the insurance policy metadata may include contractual terms associated with insurance coverages. The contractual terms that can define the insurance policy metadata may comprise coverage limits, coverage deductibles and/or elective coverage options (that is, any configurable option of the coverage (such as, for example, whether a liability coverage includes actions taken by house guests in addition to actions taken by members of the household) that may be selected and may affect the scope of the coverage and the price to be charged). In addition, the insurance policy metadata may also include options associated with coverage terms or an available endorsement. The options associated with coverage terms may comprise a set of available coverage limits and/or available deductibles to choose from. The insurance policy metadata may further comprise information regarding availability of at least one item of insurance policy metadata as a function of at least one of a given jurisdiction, a given date or a given underwriting entity. For example, a specific coverage may only be available in a certain jurisdiction. Therefore, the insurance policy metadata would include information as to the availability of the specific coverage as relates to a plurality of jurisdictions.

The insurance product model may also comprise a multi-line or “package” policy model. For example, the insurance product model can be used to create a plurality of distinct policies by choosing appropriate policy-specific data. As another example, the insurance product model may contain information about multiple lines of coverage, which can then be combined in various ways to make up “package” policies.

Product designer 102 is used to configure and/or design an insurance product model, and policy center 104 uses the insurance product model to construct and issue policies.

In the example shown, product designer 102 is shown to include insurance product model 106, which is a copy of insurance product model 105. In this example, an existing insurance product model 105 is active (i.e., live) and currently in use in the field, and product designer 102 has a copy of insurance product model 105, which can then be copied to individual user's accounts for editing. In this example, product designer 102 is shown to include insurance product model 110, which is a copy of insurance product model 106 and currently being edited by user A. User A edits and/or configures insurance product model 110 via user interface 116.

In some embodiments, product designer 102 is used to design insurance product model 105 from scratch. For example, insurance product model 106 is built up by one or more users committing one or more change lists to insurance product model 106. Then when insurance product model 106 is complete and/or ready to ship, insurance product model 106 is pushed to (e.g., copied to or otherwise transferred to) policy center 104.

In other embodiments, policy center 104 is shipped with a base version of insurance product model 105 (e.g., a base set of files), and then product designer 102 is used to edit the insurance product model and customize products for that insurance company. Thus, product designer 102 can be used to build out on the base version of an insurance product model.

For example, at Insurance Company X, User B might be an insurance agent at a local office using user interface 118 while working with a customer on setting up an insurance policy. That insurance policy would be an instance of insurance product model 105. Insurance product model 105 can be edited using product designer 102 by User A (e.g., an administrator) using user interface 116 at Insurance Company X headquarters.

In some embodiments, product designer 102 includes relationship rules table 112 and/or availability rules 114, which are used to manage insurance product model relationships, as will be more fully described below.

In some embodiments, there are three parts to managing insurance product model relationships: an administration interface to define the relationships (e.g., user interface 116); storing the relationship rules (e.g., relationship rules table 112); and building a user interface framework (e.g., user interface 118) for relationship rules to take effect with little to no additional configuration. In some embodiments, the system includes a distributed administration interface with relationship rules being entered in respective insurance product model patterns and the relationship rules in a centralized table (e.g., relationship rules table 112).

Using a centralized table as a persistence mechanism facilitates easy bulk import/export which can be very important for initial creation of rules by power users. The distributed administration interface is also consistent with the way other pattern (Coverage, Coverage Term) level information is entered in the Product Designer tool, for example Offerings.

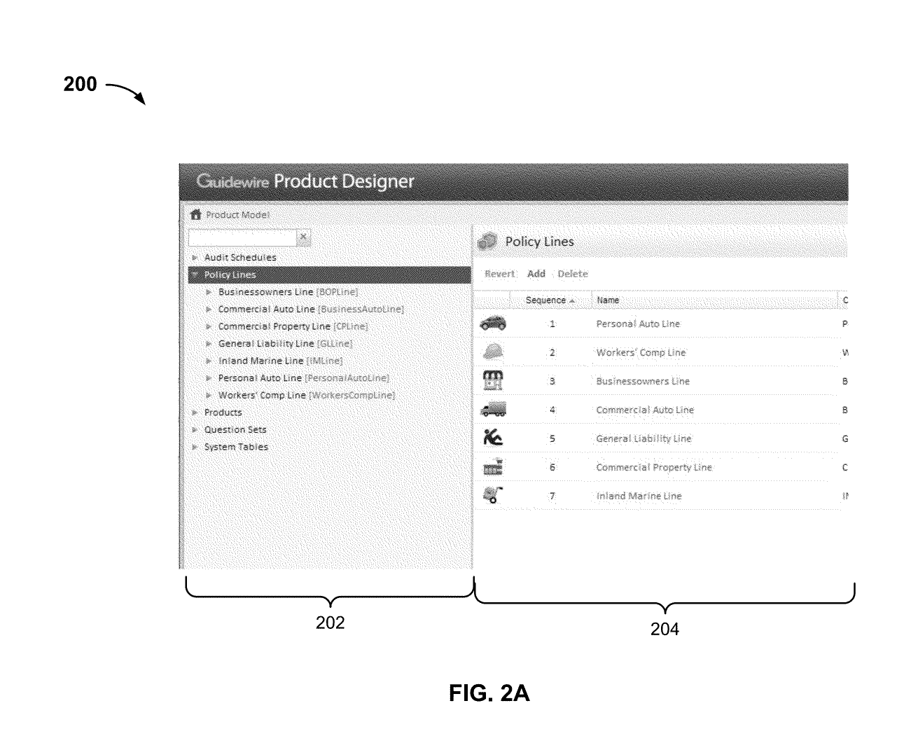

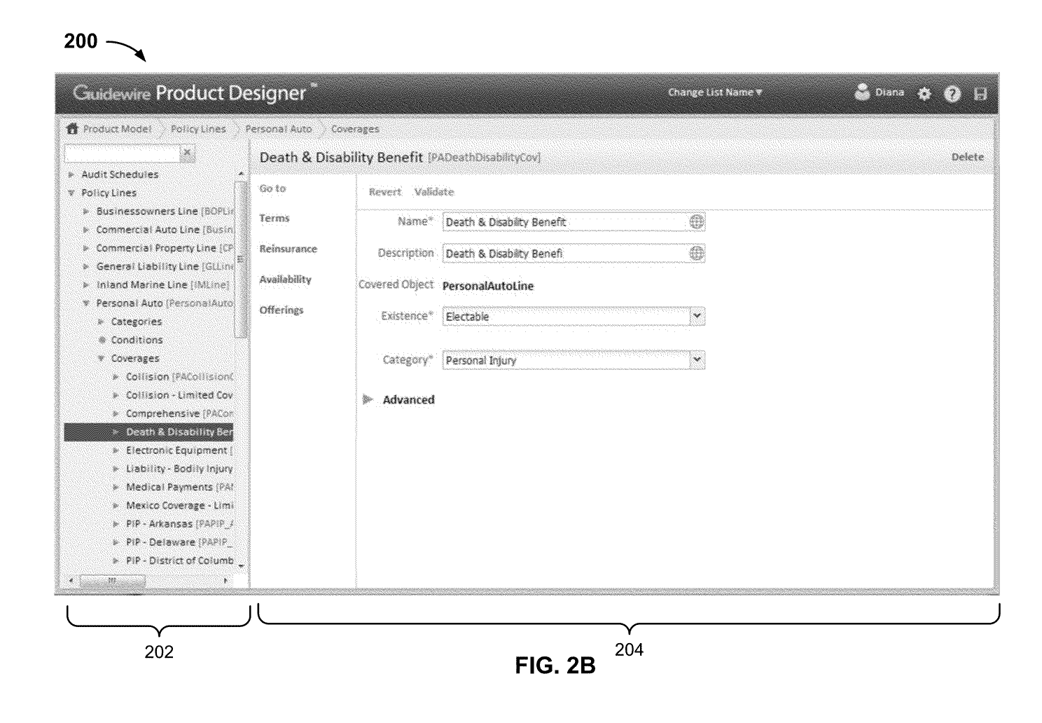

FIG. 2A is a diagram illustrating an embodiment of an interface for editing an insurance product model. When a user logs into product designer 102, the user may be presented with user interface 200, which is an example of user interface 116.

In this example, the left side of user interface 200 includes a panel 202, which displays a navigation tree that a user can navigate through to see all the elements in the insurance product model. Selecting an element in the navigation tree causes information about that item to be displayed on the right hand side 204 for viewing and/or editing. For example, details and/or editable fields associated with that element may be presented on the right hand side. In FIG. 2A, “Policy Lines” is shown as highlighted since that is what is currently selected. As a result, all the available policy lines are displayed on the right hand side.

In panel 202, five sections of an insurance product model are shown, including: audit schedules, policy lines, products, question sets, and system tables. Because “Policy Lines” is selected, all available policy lines are displayed beneath “Policy Lines” in the navigation tree (i.e., Businessowners Line, Commercial Auto Line, Commercial Property Line, General Liability Line, Inland Marine Line, Personal Auto Line, and Workers Comp Line).

FIG. 2B is a diagram illustrating an embodiment of an interface for editing an insurance product model showing the navigation tree more fully expanded. As shown in the navigation tree (panel 202), “Death & Disability Benefit” is currently selected, which falls under “Coverages,” which falls under “Personal Auto,” which falls under “Policy Lines.” In some embodiments, the elements in the navigation tree map directly to elements of the insurance product model. Panel 204 shows editable fields associated with the Death & Disability Benefit.

In some embodiments, an insurance product model includes a plurality of possible insurance product model patterns. An insurance product model pattern refers to a particular set of one or more elements in an insurance product model. For example, an insurance product model pattern may correspond to a set of elements along a path in the insurance product model navigation tree. In some embodiments, an insurance product model pattern comprises particular values for a Policy Line, Coverage, Coverage Term, and Option(s). The following is an example of one such insurance product model pattern specifying a coverage element:

Policy Line=Commercial Property Line

Coverage=Building

Coverage Term=Cause of Loss

Option(s)=Special

Insurance product model patterns may have relationships with each other, as more fully described below. Sometimes linking insurance product model patterns to one another is desired. For example, certain patterns are mutually exclusive, certain other patterns have dependent availability, etc. In some cases, customized code (e.g., availability scripts) is written to define the relationships that read the rules from system tables and then the user interface is coded to check for that relationship to trigger a screen refresh, which can be a cumbersome process. The features described herein make the definitions of insurance product model pattern relationships easier to configure. In some embodiments, a generic framework within the insurance product model editor (e.g., product designer) is used to define the relationships in table format and make the insurance product model input widgets check that information so no extra user interface configuration is required. This makes it easier for customers and service teams to configure interrelationships in the insurance product model, and for development teams to create line of business content.

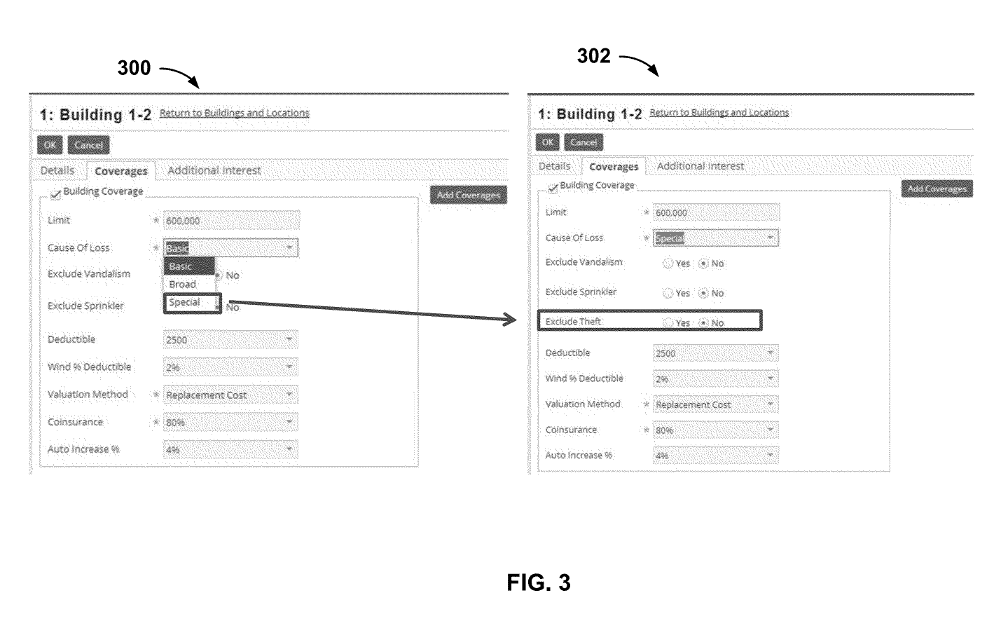

FIG. 3 is a diagram illustrating an example of an insurance product model relationship, wherein the type of relationship is dependent availability.

In this example, there is an established availability mapping between a source insurance product model pattern and a target insurance product model pattern in the insurance product model. In this case, if a first set of Coverage/Coverage Term/Option(s) insurance product model pattern is selected, then another set of Coverage/Coverage Term/Option(s) becomes available. If the first insurance product model pattern is deselected, then the second insurance product model pattern becomes unavailable.

In the example shown, user interface 300 is used by an insurance agent configuring an insurance policy for a customer. For example, in system 100, user interface 118 could be user interface 300. User B could be an insurance agent configuring a policy in Policy Center 104.

User interface 300 shows the Coverages for a commercial property. The available Coverage Terms include: Limit, Cause of Loss, Exclude Vandalism, Exclude Sprinkler, Deductible, Wind % Deductible, Valuation Method, Coinsurance, and Auto Increase %. For Cause of Loss, the available Options include: Basic, Broad, and Special.

In this example, in user interface 300, when the user (e.g., an insurance agent) selects “Special” under “Exclude Vandalism,” then Coverage Term “Exclude Theft” should be made available, as shown in user interface 302.

Thus, in this example, for insurance product model pattern Commercial Property Line/Building/Cause of Loss/Special shown in 300, there is a relationship or link with insurance product model pattern Commercial Property Line/Building/Exclude Theft/Yes or No shown in 302.

Another example of a dependent availability relationship is in Personal Auto; Rental Reimbursement Coverage should only be available if a vehicle Physical Damage Coverage has been selected.

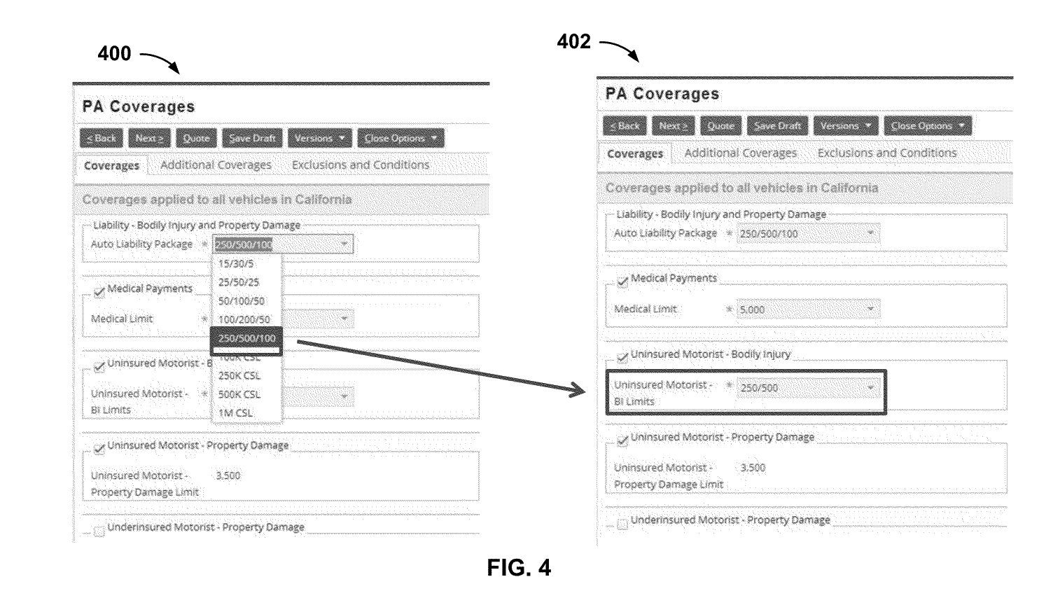

FIG. 4 is a diagram illustrating an example of an insurance product model relationship, wherein the type of relationship is dependent selection.

In this example, there is an established selection mapping between a source insurance product model pattern and a target insurance product model pattern in the insurance product model. In this case, if a first set of Coverage/Coverage Term/Option(s) insurance product model pattern is selected, then another set of Coverage/Coverage Term/Option(s) will be selected. If the first set of insurance product model patterns is deselected, then the second insurance product model pattern gets deselected.

In the example shown, user interface 400 is used by an insurance agent configuring an insurance policy for a customer. For example, in system 100, user interface 118 could be user interface 400. User B could be an insurance agent configuring a policy in Policy Center 104.

User interface 400 shows the Coverages for a personal automobile line. The available Coverage Terms include: Auto Liability Package, Medical Limit, Uninsured Motorist—BI Limits, and Uninsured Motorist—Property Damage Limit. For Auto Liability Package, the available Options include: 15/30/5, 25/50/25, 50/100/50, 250/500/100, etc. (where 15/30/5 corresponds to limits of $15,000/$30,000$5,000, etc.)

In this example, in user interface 400, when the user (e.g., an insurance agent) selects an Option under “Auto Liability Package,” then Coverage Term “Uninsured Motorist—BI Limits” is automatically set to be same as the Auto Liability Package limit. In this example, the user has selected “250/500/100,” and as a result, the Uninsured Motorist-BI Limits is automatically set to “250/500,” as shown in user interface 402.

Thus, in this example, for insurance product model pattern Personal Auto Line/Auto Liability Package, there is a relationship or link with insurance product model pattern Personal Auto Line/Uninsured Motorist—BI Limits.

Another example of a dependent selection relationship is if the options that can be selected for a field depend on what is selected in another field. For example:

If field x=100, the field y selection must be “Exclude.”

If field x=125, 200, 300, or 500, the field y selection must be “Include.”

If field x=null, the field y selections are: 25, 50, and 75 (i.e., the user may select from those three options).

In some embodiments, there are multiple dependent relationships. For example, the above scenario only applies if the state is Alaska. For other states, other deductible options may be shown.

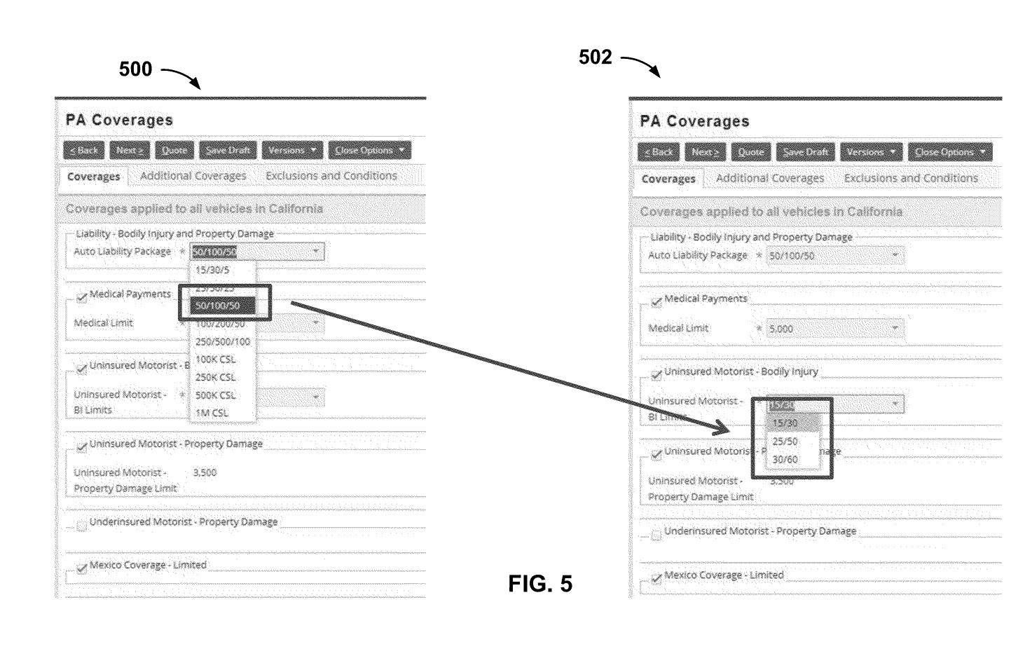

FIG. 5 is a diagram illustrating an example of an insurance product model relationship, wherein the type of relationship is dependent availability on a range.

In this example, there is a conditional availability mapping between a source insurance product model pattern and a target insurance product model pattern in the insurance product model. In other words, a target insurance product model pattern is only available if it is less than (or greater than) a source insurance product model pattern. In this case, only Coverage/Coverage Term/Option(s) less than (or greater than) a selected Coverage/Coverage Term/Option(s) insurance product model pattern are made available.

In the example shown, user interface 500 is used by an insurance agent configuring an insurance policy for a customer. For example, in system 100, user interface 118 could be user interface 500. User B could be an insurance agent configuring a policy in Policy Center 104.

User interface 500 shows the Coverages for a personal automobile line. The available Coverage Terms include: Auto Liability Package, Medical Limit, Uninsured Motorist—BI Limits, and Uninsured Motorist—Property Damage Limit. For Auto Liability Package, a variety of Options are available.

In this example, in user interface 500, when the user (e.g., an insurance agent) selects an Option under “Auto Liability Package,” then only BI limits that are less than the Auto Liability Package limit are made available under Coverage Term “Uninsured Motorist—BI Limits.” In this example, the user has selected “50/100/50,” and as a result, the Uninsured Motorist BI Limits Options only include: 15/30, 25/50, and 30/60, as shown in user interface 502.

Thus, in this example, for insurance product model pattern Personal Auto Line/Auto Liability Package, there is a relationship or link with insurance product model pattern Personal Auto Line/Uninsured Motorist—BI Limits. In this case, the relationship is dependent availability on a range.

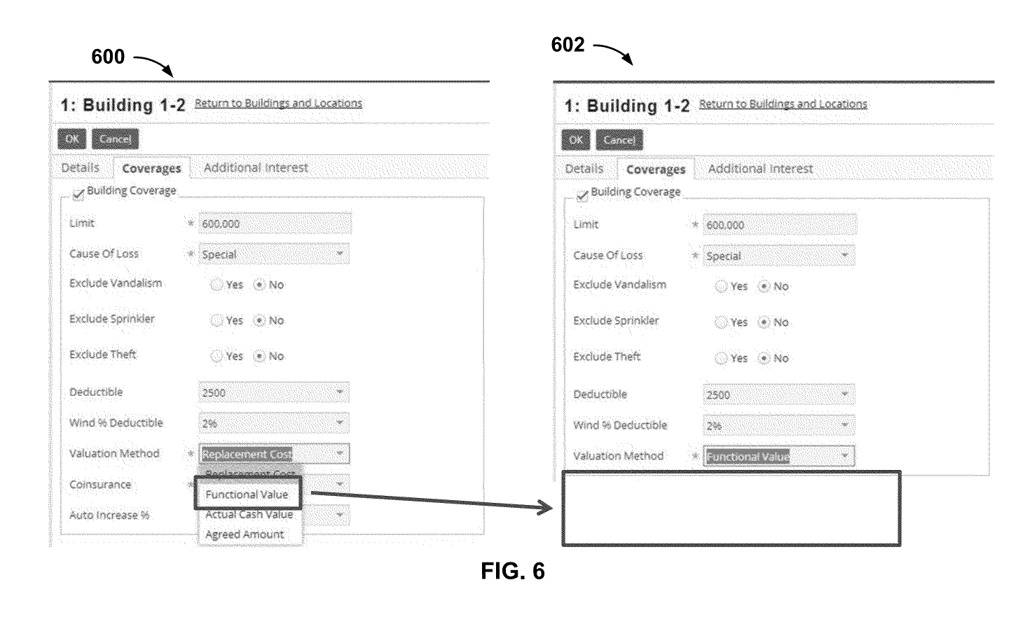

FIG. 6 is a diagram illustrating an example of an insurance product model relationship, wherein the type of relationship is dependent exclusive.

In this example, the selection of a source insurance product model pattern automatically excludes the availability of a target insurance product model pattern. In this case, if source Coverage/Coverage Term/Option(s) is selected, then target Coverage/Coverage Term/Option(s) is not available.

In the example shown, user interface 600 is used by an insurance agent configuring an insurance policy for a customer. For example, in system 100, user interface 118 could be user interface 600. User B could be an insurance agent configuring a policy in Policy Center 104.

User interface 600 shows the Coverages for a commercial property. The available Coverage Terms include: Limit, Cause of Loss, Exclude Vandalism, Exclude Sprinkler, Exclude Theft, Deductible, Wind % Deductible, Valuation Method, Coinsurance, and Auto Increase %. For Valuation Method, the available Options include: Replacement Cost, Functional Value, Actual Cash Value, and Agreed Amount.

In this example, in user interface 600, when the user (e.g., an insurance agent) selects “Functional Value” under “Valuation Method,” then Coverage Terms “Coinsurance” and “Auto Increase %” are made unavailable, as shown in user interface 602.

Thus, in this example, for insurance product model pattern Commercial Property Line/Building/Valuation Method/(Functional Value), there is a relationship or link with insurance product model pattern Commercial Property Line/Building/Coinsurance and Commercial Property Line/Building/Auto Increase %. In this case, the relationship is dependent exclusivity.

This is an example of the available choices being filtered or modified in real time, or in response to choice(s) that the user has made.

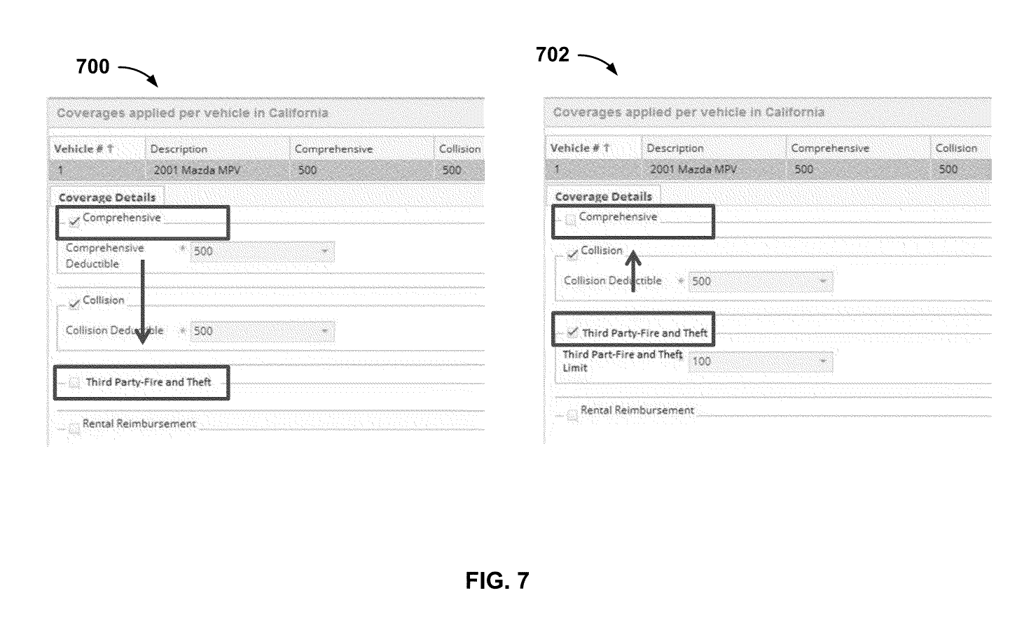

FIG. 7 is a diagram illustrating an example of an insurance product model relationship, wherein the type of relationship is mutually exclusive.

In this example, the selection of a source insurance product model pattern automatically excludes the availability of a target insurance product model pattern and vice versa. In this case, if source Coverage/Coverage Term/Option(s) is selected, then target Coverage/Coverage Term/Option(s) is not available, and vice versa. In other words, only target Coverage/Coverage Term/Option(s) or source Coverage/Coverage Term/Option(s) can be selected at one time.

In the example shown, user interface 700 is used by an insurance agent configuring an insurance policy for a customer. For example, in system 100, user interface 118 could be user interface 700. User B could be an insurance agent configuring a policy in Policy Center 104.

User interface 700 shows the Coverages for a Personal Auto Line. The available Coverage Terms include: Comprehensive, Collision, Third Party-Fire and Theft, and Rental Reimbursement.

In this example, in user interface 700, when the user (e.g., an insurance agent) selects “Comprehensive” then Coverage Term “Third Party-Fire and Theft” is automatically unchecked. If the user selects “Third Party-Fire and Theft,” then Coverage Term “Comprehensive” is automatically unchecked, as shown in 702.

Thus, in this example, for insurance product model pattern Personal Auto Line/Coverage/Comprehensive, there is a relationship or link with insurance product model pattern Personal Auto Line/Coverage/Third Party-Fire and Theft. In this case, the relationship is mutual exclusivity.

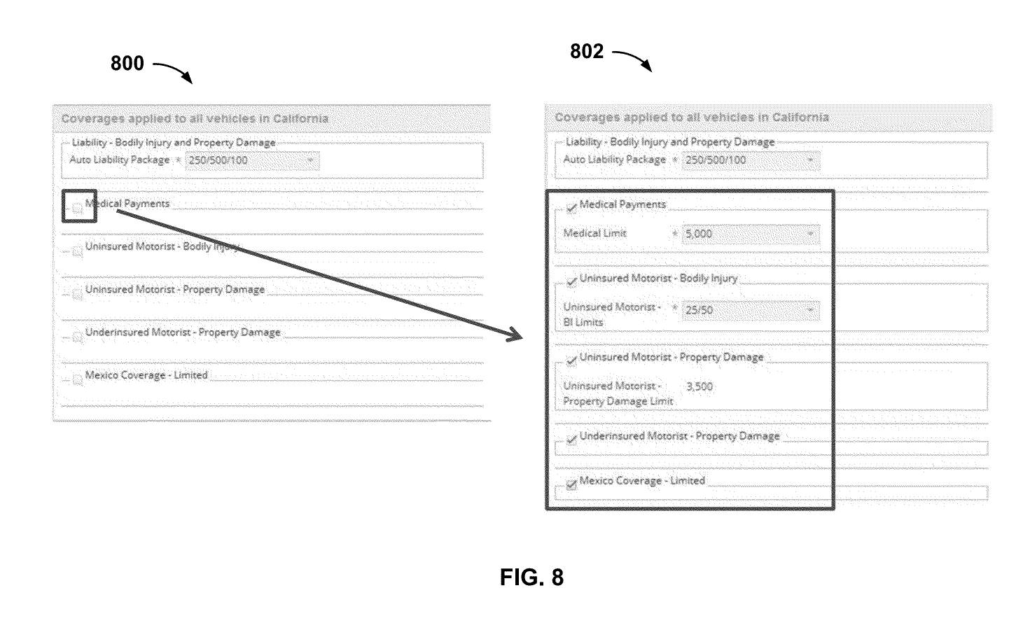

FIG. 8 is a diagram illustrating an example of an insurance product model relationship, wherein the type of relationship is dependent grouping.

In this example, the selection of a source insurance product model pattern automatically causes a group of (related) target insurance product model patterns to be selected. In other words, the user selects one and gets the bundle. In this case, if one Coverage/Coverage Term is selected, then a group of target Coverage/Coverage Terms is automatically selected. This can be considered a special case of dependent selection.

In the example shown, user interface 800 is used by an insurance agent configuring an insurance policy for a customer. For example, in system 100, user interface 118 could be user interface 800. User B could be an insurance agent configuring a policy in Policy Center 104.

User interface 800 shows the Coverages applied to all vehicles in California. The available Coverages include: Liability, Medical Payments, Uninsured Motorist—Bodily Injury, Uninsured Motorist—Property Damage, Underinsured Motorist—Property Damage, and Mexico Coverage—Limited.

In this example, in user interface 800, when the user (e.g., an insurance agent) selects “Medical Payments” then Coverages “Medical Payments,” “Uninsured Motorist—Bodily Injury,” “Uninsured Motorist—Property Damage,” “Underinsured Motorist—Property Damage,” and “Mexico Coverage—Limited” are automatically selected, as shown in 802.

Thus, in this example, for insurance product model pattern Personal Auto Line/Medical Payments, there is a relationship or link with insurance product model pattern Personal Auto Line/(“Medical Payments,” “Uninsured Motorist—Bodily Injury,” “Uninsured Motorist—Property Damage,” “Underinsured Motorist—Property Damage,” and “Mexico Coverage—Limited”). In this case, the relationship is dependent grouping.

In some embodiments, insurance product model relationships (or relationship rules) can be configured from multiple screens or levels: the coverage level, the coverage term level, and the policy line level. A relationship rule comprises the specification of a particular insurance product model relationship, such as those illustrated in FIGS. 3-8. In some embodiments, clicking on a relationship rule at the coverage, coverage term, or policy line level opens a common relationship rules user interface for that rule.

The coverage level will be described first.

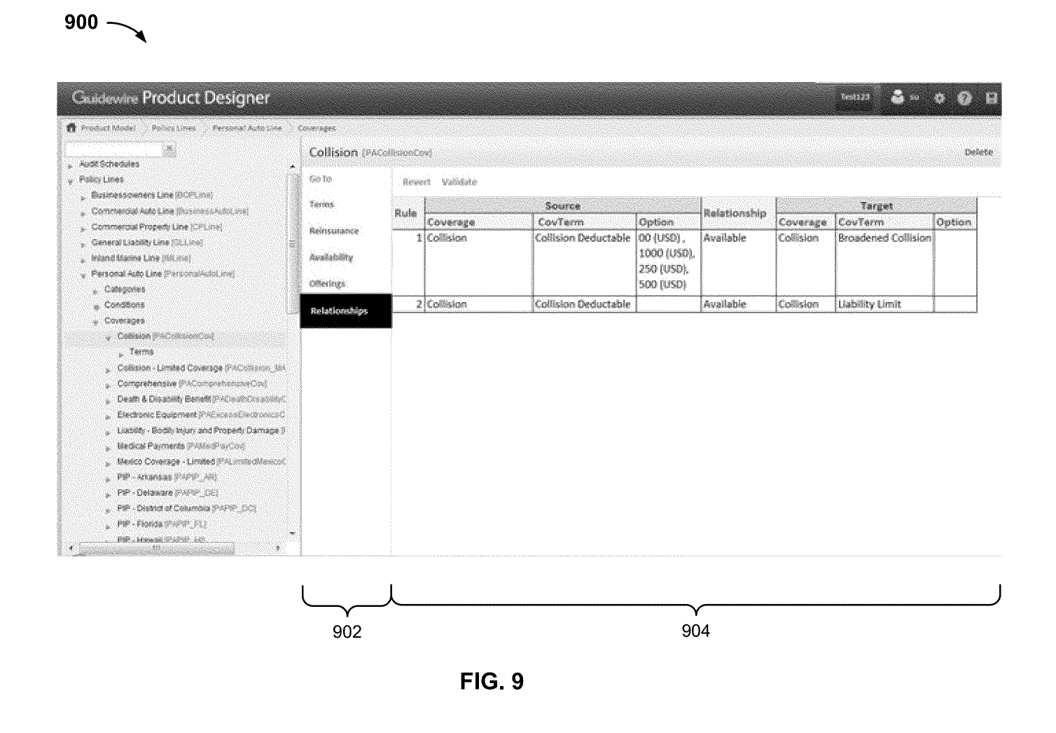

FIG. 9 is a diagram illustrating an embodiment of a user interface for configuring an insurance product model relationship from the coverage level.

In some embodiments, user interface 900 is part of user interface 116 in product designer 102. The insurance product model relationships are stored in relationship rules table 112 in product designer 102.

User interface 900 is obtained by going into a Policy Line, selecting a coverage (Collision), and selecting “Relationships” under “Go to” menu 902. This brings up coverage level relationship rules table 904. Coverage level relationship rules table 904 contains all the relationship rules applicable to that coverage.

Note that unlike the policy line level rules table below, this coverage level relationship rules table 904 only displays rules for the selected coverage, i.e., Collision. This means that all rules for which the target coverage=selected coverage are shown. In some embodiments, all rules for which the source coverage=selected coverage are also shown.

“Go to” menu 902 includes “Availability,” which allows configuring of customized code or scripts (e.g., availability scripts).

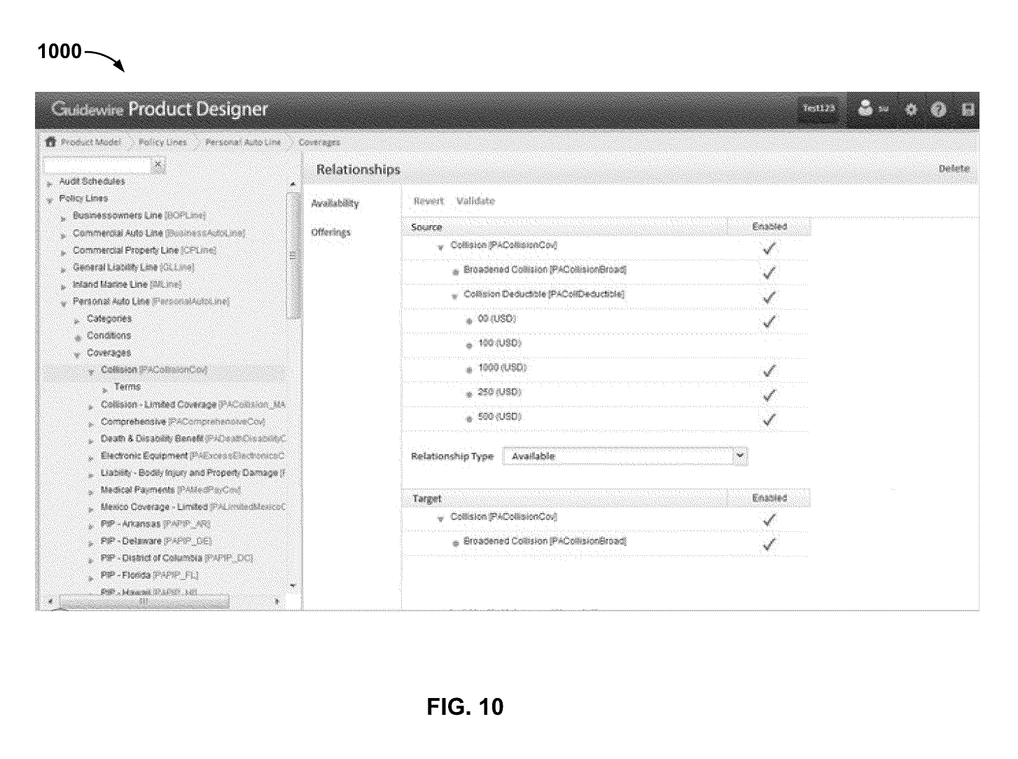

Clicking on a rule in relationship rules table 904 opens a relationship rules interface specific to that rule. For example, when User A (e.g., the admin) clicks on Rule 1, the relationship rules user interface for that rule is opened. FIG. 10 is a diagram illustrating an embodiment of a relationship rules user interface for a rule.

The relationship rules user interface 1000 allows the user to create a rule mapping a source pattern to a target pattern with the help of a relationship type. In the example shown, this rule makes the “Broadened Collision” coverage term available only if the Collision/CollisionDeductible coverage term=00, 1000, 250, or 500 because these items are checked under “Enabled.”

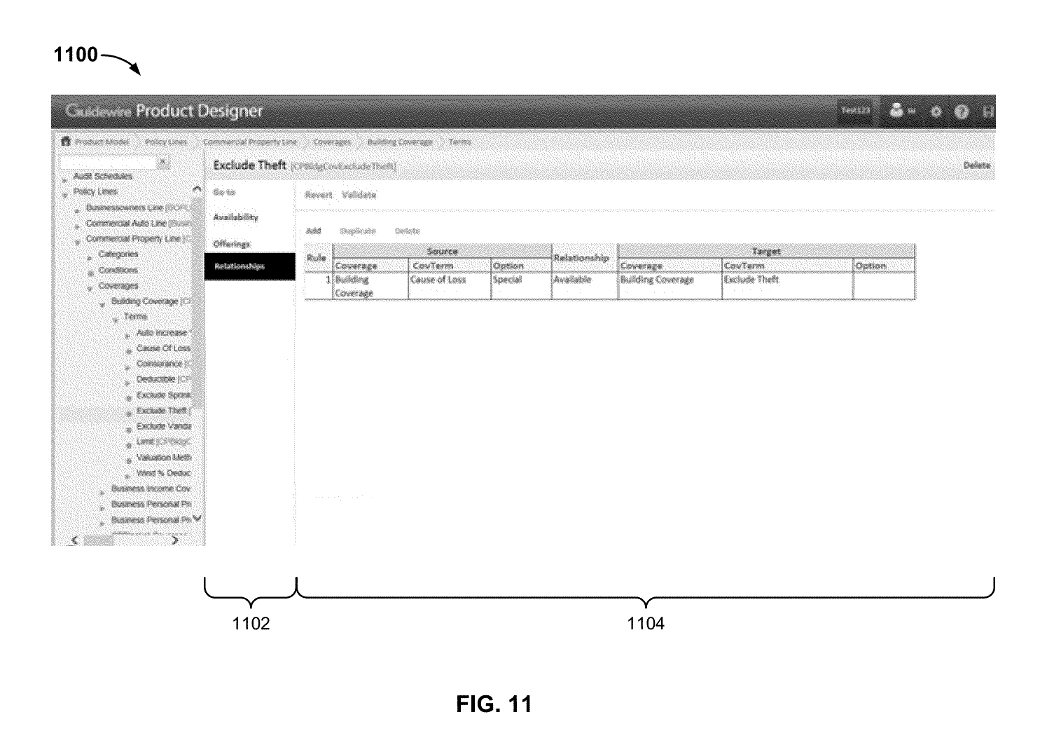

FIG. 11 is a diagram illustrating an embodiment of a user interface for configuring an insurance product model relationship from the coverage term level.

In some embodiments, user interface 1100 is part of user interface 116 in product designer 102. The insurance product model relationships are stored in relationship rules table 112 in product designer 102.

User interface 1100 is obtained by going into a Policy Line, selecting a coverage (Building Coverage), selecting a coverage term (Exclude Theft), and selecting “Relationships” under “Go to” menu 1102. This brings up coverage term level relationship rules table 1104. Coverage term level relationship rules table 1104 contains all the relationship rules applicable to that coverage term.

Note that unlike the policy line level rules table below, this coverage term level relationship rules table 1104 only displays rules for the selected coverage term, i.e., Exclude Theft. This means that all rules for which the target coverage term=selected coverage term are shown. In some embodiments, all rules for which the source coverage term=selected coverage term are also shown.

“Go to” menu 1102 includes “Availability,” which allows configuring of customized code or scripts (e.g., availability scripts).

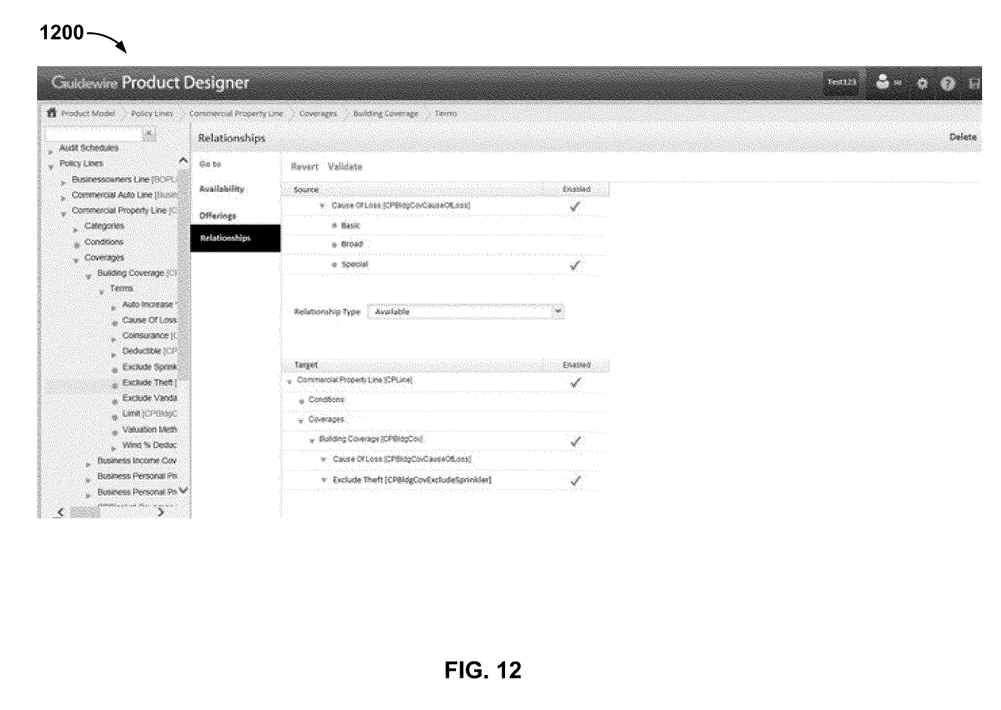

Clicking on a rule in relationship rules table 1104 opens a relationship rules interface specific to that rule. For example, when User A (e.g., the admin) clicks on Rule 1, the relationship rules user interface for that rule is opened. FIG. 12 is a diagram illustrating an embodiment of a relationship rules user interface for a rule.

The relationship rules user interface 1200 allows the user to create a rule mapping a source pattern to a target pattern with the help of a relationship type. In the example shown, this rule makes the “Exclude Theft” coverage term available only if the Cause of Loss coverage term is Special.

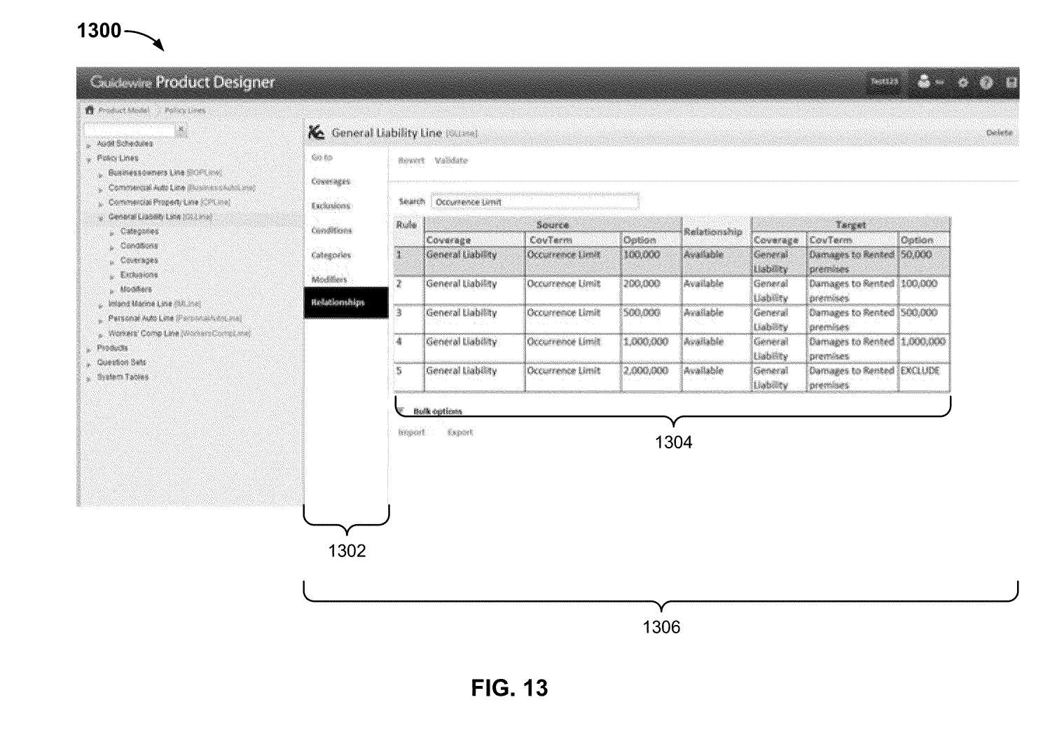

FIG. 13 is a diagram illustrating an embodiment of a user interface for configuring an insurance product model relationship from the policy line level.

In some embodiments, user interface 1300 is part of user interface 116 in product designer 102. The insurance product model relationships are stored in relationship rules table 112 in product designer 102.

User interface 1300 is obtained by going into a Policy Line (General Liability Line) and selecting “Relationships” under “Go to” menu 1302. This brings up policy line level relationship rules table 1304 in panel 1306. Policy line level relationship rules table 1304 contains all the relationship rules applicable to that policy line.

Clicking on a rule in relationship rules table 1304 opens a relationship rules interface specific to that rule. For example, when User A (e.g., the admin) clicks on Rule 1, the relationship rules user interface for that rule is opened.

In some embodiments, panel 1306 comprises a line-specific page that is divided into three sections from top to bottom: the relationship rules table 1304, related availability table and an availability script for those rules. The relationship rules table shows all the relationship rules within that policy line. When the administrator clicks on a rule, then the availability table and script for that rule is loaded and can be edited.

In some embodiments, an availability table, relationship rules table, and availability scripts are used to control whether a product model pattern is available (shows up or not) in the user interface. There is a sequence of evaluating the three items, starting with the availability table, followed by the relationship rules, and lastly the availability script. If any of the items evaluates to UNAVAILABLE, then the product model pattern doesn't show up. If any of the items evaluates to AVAILABLE, then the series of evaluation continues.

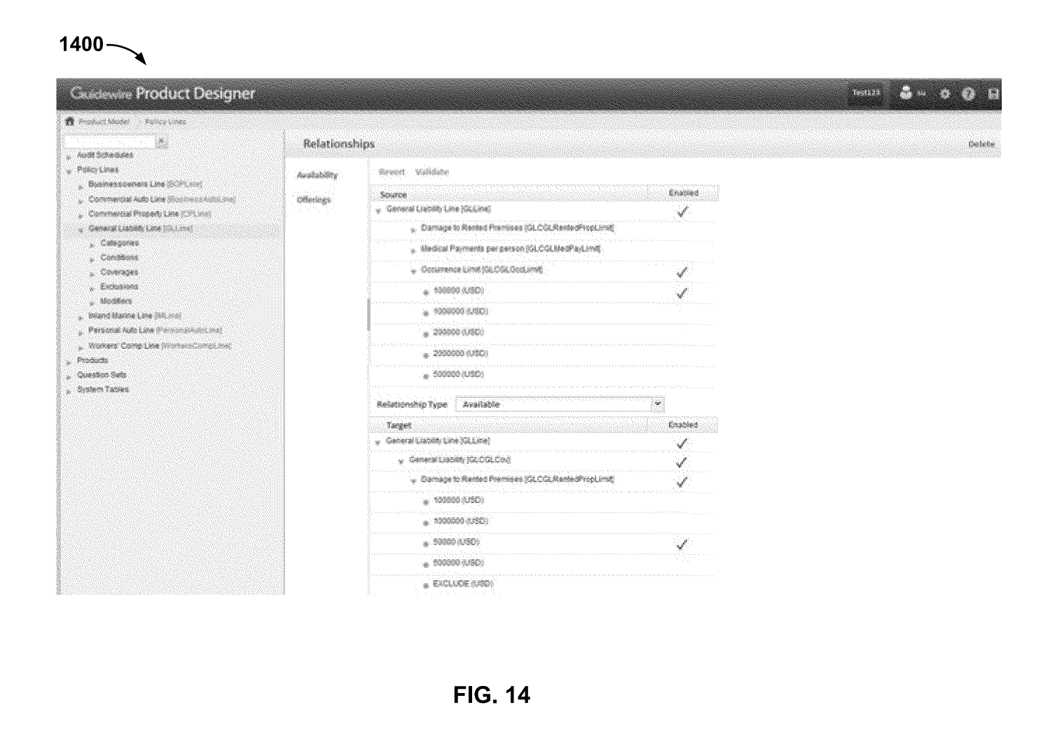

FIG. 14 is a diagram illustrating an embodiment of a relationship rules user interface for a rule. The relationship rules user interface 1400 allows the user to create a rule mapping a source pattern to a target pattern with the help of a relationship type. In the example shown, this rule makes the Damage to Rented Premises 50000 limit available only if the Occurrence Limit is 100000.

The relationship rules user interface breaks logic into a series of insurance product model pattern mappings. One or more source (insurance product model) patterns are mapped to one or more target (insurance product model) patterns with the help of a Relationship type. In some embodiments, the source and target patterns can vary from Coverage to Coverage Term to Coverage Term Options.

In some embodiments, when the admin clicks into a row on the rules table, the row becomes editable after which various menu selections become available. The relationship rules table operates under an “If Source Condition evaluates to true, then execute the Target Clause” mode.

Examples of relationship rules tables include: relationship rules tables 112, 904, 1104, and 1304. In some embodiments, the relationship rules table is stored as part of the insurance product model.

In some embodiments, the columns in the relationship rules table include:

Source Coverage/Coverage Term/Options: The Source Coverage/Coverage

Term/Options fields (e.g., the Source Coverage, Source CovTerm, and Source Option columns in table 1304) form a condition that is evaluated (collectively called the Source Condition). If this condition evaluates to true, then the Target clause is executed. In some embodiments, the Coverage Term/Options menus are multi-select drop down menus that allow the admin user to select one or more Coverage Term Options. The source condition is evaluated using this Coverage/Coverage Terms to determine if the relationship rule applies (hence the term Source). In some embodiments, these menus use widgets that have check boxes alongside each option in the pull-down menu to allow selection of multiple Coverage Terms Options. The selections in the Coverage menu progressively filter the Coverage Terms available in the Coverage Terms menu, as well as the Options available. In some embodiments, it is mandatory to select at least one Source Coverage option, but not necessary to select any Coverage Term since the Source condition can be formed with Coverages.

Target clause fields: The Target Coverage/Coverage Term/Option fields (e.g., the Target Coverage, Target CovTerm, and Target Option columns in table 1304) form a target (or action) clause that is somehow constrained if the Source Condition is evaluated to be true. In some embodiments, the target Coverage Term/Options menus are multi-select drop down menus that allow the admin user to select more than one Coverage Term or Option. The selected Coverage Terms/Options will be constrained in some manner if the Source Condition is evaluated to be true (hence referred to as Target). In some embodiments, these menus use widgets that have check boxes alongside each Coverage Term/Option to allow multiple selections. The selections in the Coverage menu progressively filter the Coverage Terms available in the Coverage Terms menu. In some embodiments, it is mandatory to select at least one Target Coverage option, but not necessary to select any Coverage Term since the Target clause can be a Coverage.

Relationship (e.g., the Relationship column in table 1304): This is a menu of Relationship Types, and specifies the nature of the relationship between the Source and Target patterns. Only one relationship type can be selected per row in the rules table.

In some embodiments, the Relationship Types include the following, where a pattern refers to an insurance product model pattern:

Available: If Source pattern is selected, then make Target pattern available. If Source pattern is unselected, then make Target pattern unavailable. An example of this relationship type is shown in FIG. 3.

One-way Exclusive: If Source pattern is selected, then make Target pattern un-available. If Source pattern is un-selected, then make Target pattern available. An example of this relationship type is shown in FIG. 6.

Mutually Exclusive: If Source pattern is selected, then make Target pattern un-available. If Source pattern is un-selected, then make Target pattern available. If Target pattern is selected, then make Source pattern un-available. If Target pattern is un-selected, then make Source pattern available. An example of this relationship type is shown in FIG. 7.

Set: If Source pattern is selected, then select Target pattern. Examples of this relationship type are shown in FIGS. 4 and 8.

Less Than: Make all Target Coverage Term Options available for which selected Source Coverage/Coverage Term Option value is less than Target Coverage Term Option.

Greater Than: Make all Target Coverage Term Options available for which selected Source Coverage/Coverage Term Option value is greater than Target Coverage Term Option. An example of this relationship type is shown in FIG. 5.

Equal to: Make all Target Coverage Term Options available for which selected Source Coverage/Coverage Term Option value is equal to Target Coverage Term Option.

Relationship types “Less Than,” “Greater Than,” and “Equal to” can be considered special cases of Dependent availability on a range.

Certain relationship types, such as Less Than, Greater Than and Equal To, use the Value field on Coverage Term Options. The Value field is an integer value corresponding to each Coverage Term option and is sometimes equal to the integer value of the Coverage Term description. In the event that the Coverage Term description is a phrase, this is useful in evaluating comparison.

In some embodiments, it is possible that a user would want to define relationships like “coverage X is available if coverage Y or coverage Z is selected.” This could be supported by building relationship types associated with the OR scenario. In some embodiments, the user could define the OR scenario themselves. Rather than strictly defining rows in a table, the user interface can be constructed by adding fields within a standard panel, and allowing the user to define parentheses and select logical AND/OR between each condition.

The user (e.g., an administrator) defines relationships between insurance product model patterns in the relationship rules table. In some embodiments, the user defines insurance product model relationships in one centralized table.

In some embodiments, the user defines insurance product model relationships in multiple tables. It is up to the user on how to split up various rules across different tables. If the number of relationship rules is manageable in one table, then the user can create one table with all the rules for a policy line. If there are a large number of rules to a policy line, then the user may choose to split them up into different rules tables. In some embodiments, each policy line has at least one table with its relationship rules. The user can maintain the tables and the rules from this table. In some embodiments, maintaining a table refers to creating a new table, loading the contents of a different table, deleting a table, and/or saving changes to a table. Maintaining rules refers to adding new rules, deleting rules, and/or editing existing rules.

In some embodiments, it is possible to extend and/or create new Relationship Types. In some embodiments, the behavior of the relationship type between the Source and Target patterns is first modeled before being used in practice.

In some embodiments, each relationship rule has an availability table and an availability script. When the user clicks on a relationship rule, then the corresponding availability table and availability script for that rule is displayed in the page. A relationship rule is only valid when it is available. It is possible to click into the availability table and availability scripts for a rule and fill-in.

Because each relationship rule has its own availability table and availability script there may be interaction effects that require re-evaluation of availability for relationship rules in different screens. As an example, if a user changes the State in a screen from NJ to CA for which a relationship rule becomes available, this requires re-evaluation of the availability calculations for the relationship rule and then re-evaluation of the rule conditions itself. Various ways to cache the re-evaluations may be used to efficiently minimize the performance and complexity impact. For example, one performance-saving technique is to “lazy-evaluate” the availability of relationship rules. This means that if a pattern becomes available, then the system can check the availability of only those relationship rules that potentially affect that pattern.

In some embodiments, the relationship rules table is stored in a centralized XML file as part of the insurance product model. An example of an XML file for relationship rules table 904 is as follows:

```
<?xml version=“1.0”?>
<RelationshipTable
  <Relationship
  <Source
    coverage=“Collision”
    covTerm=“Collision Deductable”
    <Option
      <OptionTerm
        Term=“00”/>
      <OptionTerm
            Term=“250”/>
      <OptionTerm
            Term=“500”/>
      <OptionTerm
            Term=“1000”/>
    />
    />
    <RelationshipType=“Available”/>
  <Target
    coverage=“Collision”
    covTerm=“Broadened Collision”
    />
  />
  <Relationship
  <Source
    coverage=“Collision”
    covTerm=“Collision Deductable”
    />
    <RelationshipType=“Available”/>
  <Target
    coverage=“Collision”
    covTerm=“Liability Limit”
    />
  />
/>
```

In some embodiments, the relationship rules can be imported and/or exported. For example, if a user wishes to enter multiple relationship rules at once, a convenient way is to use bulk import/export functionality. This would support reading in (and writing to) an aggregated Relationship Rules table at the policy line level all at once. Bulk import/export functionality is well suited to initial creation of relationship rules.

In some embodiments, availability for tables and scripts is stored in XML files and mirrored in a database, with the ability to reload the database dynamically during run-time. In some embodiments, insurance product model relationship rules are implemented by extending availability and the ability to reload relationship rules dynamically to the database, i.e., dynamic loading of relationship rules into the database during run-time. In other embodiments, the server is restarted to update relationship rule changes.

In some embodiments, the relationship rules table can store unique identifiers (instead of words) for the source and target insurance product model patterns, which would improve efficiency. For example, the source insurance product model pattern could have a unique identifier and the target could have a unique identifier.

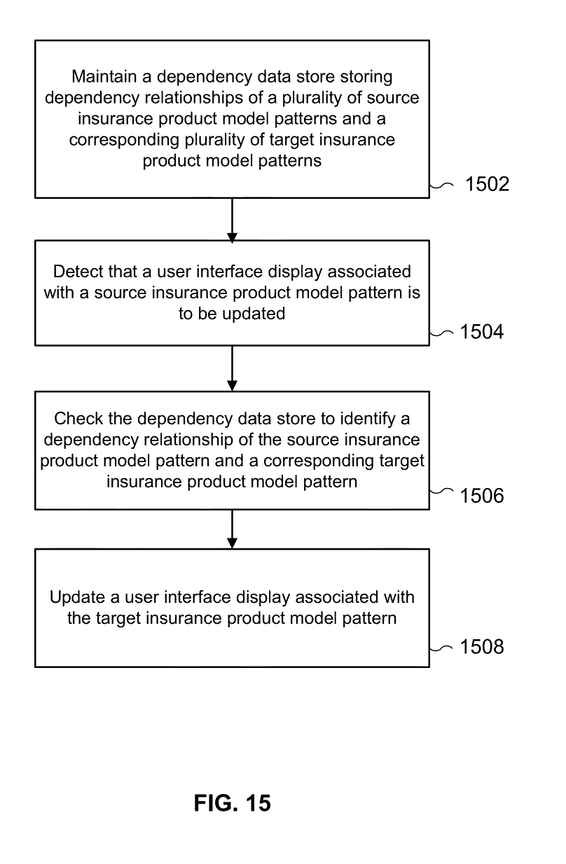

FIG. 15 is a flow chart illustrating an embodiment of a process for managing insurance product model relationships.

At 1502, a dependency data store storing dependency relationships between a plurality of source insurance product model patterns and a corresponding plurality of target insurance product model patterns is maintained. Examples of a dependency data store include: a database, a table, an insurance product model, and persistent memory. Examples of dependency relationships include relationship rules tables 112, 904, 1104, and 1304. An example of a dependency relationship is a relationship rule (one row) in the relationship rules table, such as Rule 1 in relationship rules table 904. In some embodiments, a dependency relationship includes: a source coverage, source coverage term, source option, relationship, and a target coverage, target coverage term, and target option.

At 1504, an indication that a user interface display associated with a source insurance product model pattern is to be updated is detected. In some embodiments, the user interface display is user interface 118.

For example, a user selecting a field that is associated with a source insurance product model pattern may trigger the indication. For example, in FIG. 3, in user interface 300, when the user selects “Special” under “Exclude Vandalism,” then user interface 300 is updated to user interface 302.

In some embodiments, a user adding a new dependency relationship to the relationship rules table or editing a dependency relationship in the relationship rules table, could trigger the indication.

At 1506, the dependency data store is checked to identify a dependency relationship between the source insurance product model pattern and a corresponding target insurance product model pattern.

For example, the relationship rules table is checked for a dependency relationship between a source insurance product model pattern and a corresponding target insurance product model.

For example, in user interface 300, if a user selects “Special,” then a relationship rules table is checked. The relationship rules table would indicate that for insurance product model pattern Commercial Property Line/Building/Cause of Loss/Special, there is a relationship with insurance product model pattern Commercial Property Line/Building/Exclude Theft/Yes or No. The Relationship Type is “Available.”

At 1508, a user interface display associated with the target insurance product model pattern is updated. For example, user interface 300 is updated to user interface 302, in which Coverage Term “Exclude Theft” is available. As such, the available choices in the user interface are being filtered or modified in real time, or in response to choice(s) that the user has made.

When adding or editing a relationship rule, rather than having to make edits in multiple places in the code (e.g., both edit an availability script and edit the user interface code to reflect the relationship rule), the relationship rule is added or edited and stored in a single place, e.g., a relationship rules table. The user interface can access the insurance product model and relationship rules table so that the edit can take effect automatically. The user interface code checks the relationship rules tables so it is automatically aware of any changes. In some embodiments, when the user inputs (e.g., a selection) to a user interface element, the user interface element (e.g., widget) is configured to check the relationship rules table and if there is a rule associated with that insurance product model pattern that changes a target element, the target element is automatically refreshed to reflect the change. In some embodiments, only the affected part of the user interface is refreshed. This is more efficient than having to hard code the new or edited relationship rule in multiple places, including specifically writing code for each affected element (e.g., configuring the user interface for each relationship/dependency).

In some embodiments, the first time a page is loaded (e.g., when the user opens the page), part of the information loaded includes which elements have dependencies, so that when the user makes a selection associated with one of those elements, the user interface knows to check for a dependency. In some embodiments, if a new dependency is added to the relationship rules table, the user interface refreshes to load that information, or the user interface relationship rules table is checked periodically or at a preconfigured event(s) or time(s) for changes, after which the user interface may refresh to load the change(s).

In some embodiments, the product coverage screens in the policy center are configured in an automated fashion so that no further configuration is needed once relationship rules are created or modified. For example, for the “Available” relationship type, for an insurance product model pattern input set, the visibility rules check the availability tables, scripts, and relationship rules table for that insurance product model pattern. Checking the relationship rules table evaluates the conditional dependencies that could show or hide the pattern. Additionally, the container that has all the Coverage and Coverage Term iterators in it is refreshed, every time any other Coverage or Coverage Term value is modified. This means that the user interface widget refresh attribute is set for every Coverage and Coverage Term in the iterator to target the container. In some embodiments, the user interface widget refresh attributes only set on the Coverages and not on every Coverage Term.

In some embodiments, each element has visibility rules associated with it. When the insurance product model pattern elements are being rendered, then the element visibility rules take the insurance product model pattern's availability and relationship rules table into account. Overall availability is evaluated by ANDing (i.e., the conditions of all rows must be met in order for the insurance product model pattern to remain available) the following:

Relationship rule level table lookup—look up every rule in each relationship rule table.

Relationship rule level availability rule for corresponding relationship rules.

Insurance product model pattern level availability rule.

Insurance product model pattern level availability script.

In some embodiments, which items are checked and/or the order in which the items are checked is user configurable.

Out of Sequence Changes

In some cases, an out of sequence change can occur and a conflict is created for one of the insurance product model patterns involved in a relationship between its value at two different slice dates. In some embodiments, there is an out of sequence conflict resolution user interface that allows the user to make a change. In some embodiments, the out of sequence conflict resolution user interface can render the relationships so that the user does not or cannot make a change that violates the defined relationship. In other embodiments, the insurance product model is synchronized immediately following out of sequence conflict resolution and sends the user back to the out of sequence conflict resolution user interface if a problem is found.

An example of an out of sequence change and conflict resolution user interface is the following:

Policy term is from January to January

A business rule prevents a policy from having both coverage A and coverage B at the same time.

Policy change to add coverage A effective starting in March

Policy change to add coverage B effective starting February (out of sequence).

In some embodiments, there is a mechanism to prevent having both coverage A and coverage B as of April. For example, Coverage B should be effective from February to March, and then only Coverage A should be effective from March to term end. In some embodiments, a conflict resolution user interface is triggered when quoting the out of sequence policy change, asking the user to resolve the conflict, for example, either: (1) choose Coverage B from February to March and then Coverage A from March to term end, or (2) choose Coverage B from February to end of term.

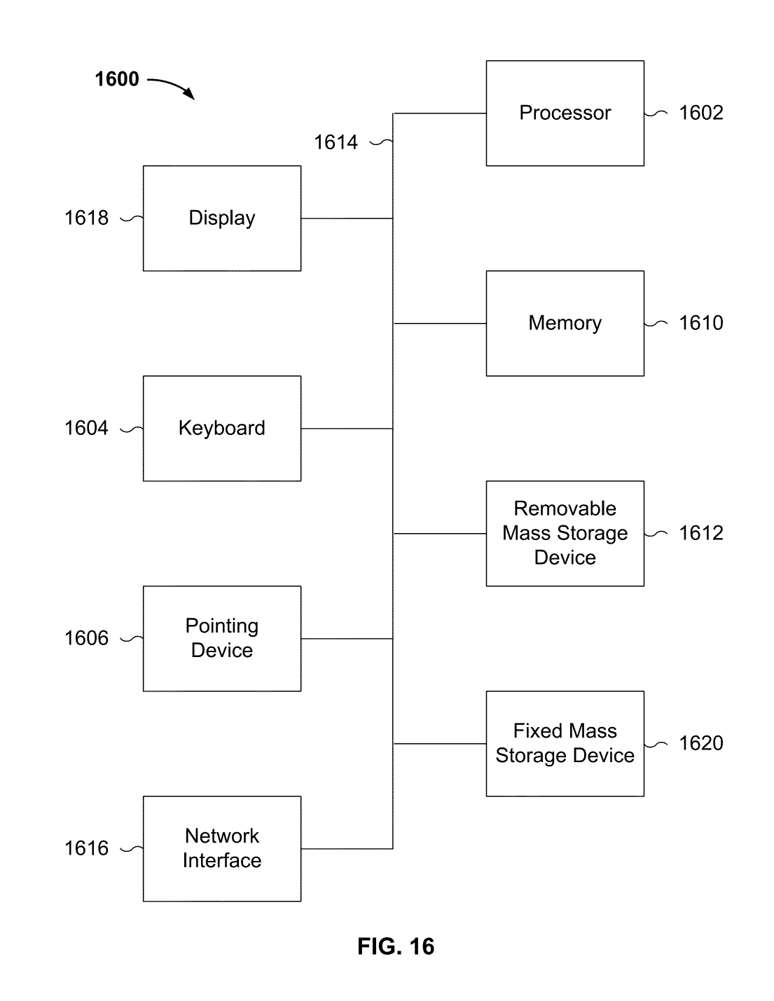

FIG. 16 is a functional diagram illustrating a programmed computer system for managing insurance product model relationships in accordance with some embodiments. As will be apparent, other computer system architectures and configurations can be used to manage insurance product model relationships. Computer system 1600, which includes various subsystems as described below, includes at least one microprocessor subsystem (also referred to as a processor or a central processing unit (CPU)) 1602. For example, processor 1602 can be implemented by a single-chip processor or by multiple processors. In some embodiments, processor 1602 is a general purpose digital processor that controls the operation of the computer system 1600. Using instructions retrieved from memory 1610, the processor 1602 controls the reception and manipulation of input data, and the output and display of data on output devices (e.g., display 1618). In some embodiments, processor 1602 includes and/or is used to provide product designer 102 and/or policy center 104 described with respect to FIG. 1 and/or executes/performs the processes described above with respect to FIG. 15.

Processor 1602 is coupled bi-directionally with memory 1610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1602. Also as is well known in the art, primary storage typically includes basic operating instructions, program code, data, and objects used by the processor 1602 to perform its functions (e.g., programmed instructions). For example, memory 1610 can include any suitable computer-readable storage media, described below, depending on whether, for example, data access needs to be bi-directional or uni-directional. For example, processor 1602 can also directly and very rapidly retrieve and store frequently needed data in a cache memory (not shown).

A removable mass storage device 1612 provides additional data storage capacity for the computer system 1600, and is coupled either bi-directionally (read/write) or uni-directionally (read only) to processor 1602. For example, storage 1612 can also include computer-readable media such as magnetic tape, flash memory, PC-CARDS, portable mass storage devices, holographic storage devices, and other storage devices. A fixed mass storage 1620 can also, for example, provide additional data storage capacity. The most common example of mass storage 1620 is a hard disk drive. Mass storage 1612, 1620 generally store additional programming instructions, data, and the like that typically are not in active use by the processor 1602. It will be appreciated that the information retained within mass storage 1612 and 1620 can be incorporated, if needed, in standard fashion as part of memory 1610 (e.g., RAM) as virtual memory.

In addition to providing processor 1602 access to storage subsystems, bus 1614 can also be used to provide access to other subsystems and devices. As shown, these can include a display monitor 1618, a network interface 1616, a keyboard 1604, and a pointing device 1606, as well as an auxiliary input/output device interface, a sound card, speakers, and other subsystems as needed. For example, the pointing device 1606 can be a mouse, stylus, track ball, or tablet, and is useful for interacting with a graphical user interface.

The network interface 1616 allows processor 1602 to be coupled to another computer, computer network, or telecommunications network using a network connection as shown. For example, through the network interface 1616, the processor 1602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1602 can be used to connect the computer system 1600 to an external network and transfer data according to standard protocols. For example, various process embodiments disclosed herein can be executed on processor 1602, or can be performed across a network such as the Internet, intranet networks, or local area networks, in conjunction with a remote processor that shares a portion of the processing. Additional mass storage devices (not shown) can also be connected to processor 1602 through network interface 1616.

An auxiliary I/O device interface (not shown) can be used in conjunction with computer system 1600. The auxiliary I/O device interface can include general and customized interfaces that allow the processor 1602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 16 is but an example of a computer system suitable for use with the various embodiments disclosed herein. Other computer systems suitable for such use can include additional or fewer subsystems. In addition, bus 1614 is illustrative of any interconnection scheme serving to link the subsystems. Other computer architectures having different configurations of subsystems can also be utilized.

Managing insurance product model relationships has been described. The described features allow greater configuration capability to business analysts and other non-technical users to own and maintain insurance product model relationships.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for managing insurance product model relationships, comprising:
one or more memories configured to:
maintain a dependency data store storing dependency relationships of a plurality of source insurance product model patterns and a corresponding plurality of target insurance product model patterns; and
one or more processors configured to:
detect that a user interface display associated with a source insurance product model pattern is to be updated;
check the dependency data store to identify a dependency relationship of the source insurance product model pattern and a corresponding target insurance product model pattern; and
update a user interface display associated with the target insurance product model pattern;
wherein the one or more memories are coupled to the one or more processors and configured to provide the one or more processors with instructions.

2. The system recited in claim 1, wherein the dependency data store comprises a database, a table, an insurance product model, or persistent memory.

3. The system recited in claim 1, wherein the dependency relationships are included in a relationship rules table.

4. The system recited in claim 3, wherein the relationship rules table comprises the source insurance product model pattern, the dependency relationship, and the target insurance product model pattern.

5. The system recited in claim 4, wherein the source insurance product model pattern includes: a source coverage, a source coverage term, and a source option, and the target insurance product model pattern includes a coverage, target coverage term, and target option.

6. The system recited in claim 3, wherein the dependency relationship specifies an availability mapping between the source insurance product model pattern and the target insurance product model pattern.

7. The system recited in claim 6, wherein the relationship comprises one or more of: Available, One-way Exclusive, Mutually Exclusive, Set, Less Than, Greater Than, and Equal to.

8. The system recited in claim 6, wherein the relationship is such that if the source insurance product model pattern is selected, then the target insurance product model pattern is made available.

9. The system recited in claim 6, wherein the relationship is such that if the source insurance product model pattern is selected, then the target insurance product model pattern is automatically selected.

10. The system recited in claim 6, wherein the relationship is such that only the source insurance product model pattern or the target insurance product model pattern can be selected at one time.

11. The system recited in claim 6, wherein the relationship is user defined.

12. The system recited in claim 1, wherein detecting includes detecting that a user has selected a field that is associated with the source insurance product model pattern included in the dependency relationships.

13. The system recited in claim 1, wherein detecting includes detecting that a user has added a new dependency relationship or edited a dependency relationship.

14. The system recited in claim 1, wherein checking the dependency data store includes checking a row in a relationship rules table associated with the dependency relationship.

15. The system recited in claim 1, wherein the dependency relationships only need to be stored in a single location and a user interface only needs to check the single location for the dependency relationships.

16. The system recited in claim 1, wherein a user interface has access to an insurance product model and the dependency data store.

17. The system recited in claim 16, wherein the user interface is configured to automatically check the dependency data store.

18. The system recited in claim 1, wherein the dependency relationships are configurable via an insurance product model editor and the user interface display is associated with policy center software for configuring an insurance policy, wherein the policy center software resides on a separate device from the insurance product model editor.

19. A method of managing insurance product model relationships, comprising:
maintaining a dependency data store storing dependency relationships of a plurality of source insurance product model patterns and a corresponding plurality of target insurance product model patterns;
detecting that a user interface display associated with a source insurance product model pattern is to be updated;
checking the dependency data store to identify a dependency relationship of the source insurance product model pattern and a corresponding target insurance product model pattern; and
updating a user interface display associated with the target insurance product model pattern.

20. A computer program product for managing insurance product model relationships, the computer program product being embodied in a tangible computer readable storage medium and comprising computer instructions for:
maintaining a dependency data store storing dependency relationships of a plurality of source insurance product model patterns and a corresponding plurality of target insurance product model patterns;
detecting that a user interface display associated with a source insurance product model pattern is to be updated;
checking the dependency data store to identify a dependency relationship of the source insurance product model pattern and a corresponding target insurance product model pattern; and
updating a user interface display associated with the target insurance product model pattern.
